(19) United States
(12) Patent Application Publication
(10) Pub. No.: US 2025/0095617 A1
(43) Pub. Date: Mar. 20, 2025

(54) DISPLAY DEVICE, ELECTRONIC MUSICAL INSTRUMENT, DISPLAY CONTROL METHOD AND STORAGE MEDIUM

(71) Applicant: CASIO COMPUTER CO., LTD., Tokyo (JP)

(72) Inventors: Shingo OKANO, Tokyo (JP); Tomoya KAJIKAWA, Tokyo (JP); Osamu MORIYAMA, Tokyo (JP); Yumi AIHARA, Tokyo (JP)

(21) Appl. No.: 18/890,042

(22) Filed: Sep. 19, 2024

(30) Foreign Application Priority Data
Sep. 20, 2023 (JP) 2023-151847

(51) Int. Cl. G10H 1/00; G10H 1/34

(52) U.S. Cl. CPC G10H 1/0016; G10H 1/34; G10H 2220/061; G10H 2220/221

(57) ABSTRACT

A display device includes a display and a processor. The display displays one piece of a plurality of pieces of information and does not display two or more pieces of the plurality of pieces of information simultaneously. The processor causes the display to preferentially display a second piece of information included in the plurality of pieces of information rather than a first piece of information included in the plurality of pieces of information in accordance with a set priority order. The first piece of information corresponds to a performance operation of a user, and the second piece of information assists a performance of the user.

### CROSS-REFERENCE TO RELATED APPLICATIONS

This application is based upon and claims the benefit of priority from the prior Japanese Patent Application No. 2023-151847, filed on Sep. 20, 2023, the entire contents, including the description, claims, abstract and drawings, of which are incorporated herein by reference.

### TECHNICAL FIELD

The present disclosure relates to a display device, an electronic musical instrument, a display control method and a storage medium.

### DESCRIPTION OF RELATED ART

There is disclosed in JP 2018-77319 A a guide display of an electronic keyboard instrument having, for each key, four indicator lights that are a first advance notice light 41, a second advance notice light 42, a third advance notice light 43 and a key press instruction light 44.

### SUMMARY OF THE INVENTION

According to an aspect of the present disclosure, there is provided a display device including:
a display that displays one piece of a plurality of pieces of information and does not display two or more pieces of the plurality of pieces of information simultaneously; and
a processor that causes the display to preferentially display a second piece of information included in the plurality of pieces of information rather than a first piece of information included in the plurality of pieces of information in accordance with a set priority order, the first piece of information corresponding to a performance operation of a user and the second piece of information assisting a performance of the user.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a block diagram showing a functional configuration of an electronic musical instrument according to the present disclosure;

FIG. 2 shows an example of the external configuration of the electronic musical instrument shown in FIG. 1;

FIG. 3A shows an example of a display pattern of a display shown in FIG. 1 corresponding to a case where the strength of key press in a user performance, the degree of pedal depression, or the strength of key press in a model performance is at the lowest level;

FIG. 3B shows an example of a display pattern of the display shown in FIG. 1 corresponding to a case where the strength of key press in a user performance, the degree of pedal depression, or the strength of key press in a model performance is at the highest level;

FIG. 4 shows an example of a display pattern of the display shown in FIG. 1 corresponding to metronome indications;

FIG. 5 shows an example of a display pattern of the display shown in FIG. 1 corresponding to error information;

FIG. 6 is a flowchart of a display control process that is performed by a CPU shown in FIG. 1;

FIG. 7 is a flowchart of a process of displaying information categorized as Group B shown in FIG. 6; and

FIG. 8 is a flowchart of a process of displaying information categorized as Group A shown in FIG. 6.

### DETAILED DESCRIPTION

The guide display disclosed in JP 2018-77319 A notifies a user about information pertaining to the timing of key press only. However, if a single display displays a piece of information by switching pieces of information, which are, for example, information pertaining to user's performance operations (e.g., information on the strength of key press) and information assisting a performance (e.g., information on metronome indications), the display may not display information necessary for the user.

It is preferable that a display device of an electronic musical instrument can display information necessary for its user well.

Hereinafter one or more embodiments of the present disclosure will be described with reference to the drawings.

The embodiments described below are provided with various technically preferred limitations for carrying out the present disclosure.

The technical scope of the present disclosure is not limited to the embodiments below or illustrated examples.

### [Configuration of Electronic Musical Instrument 100]

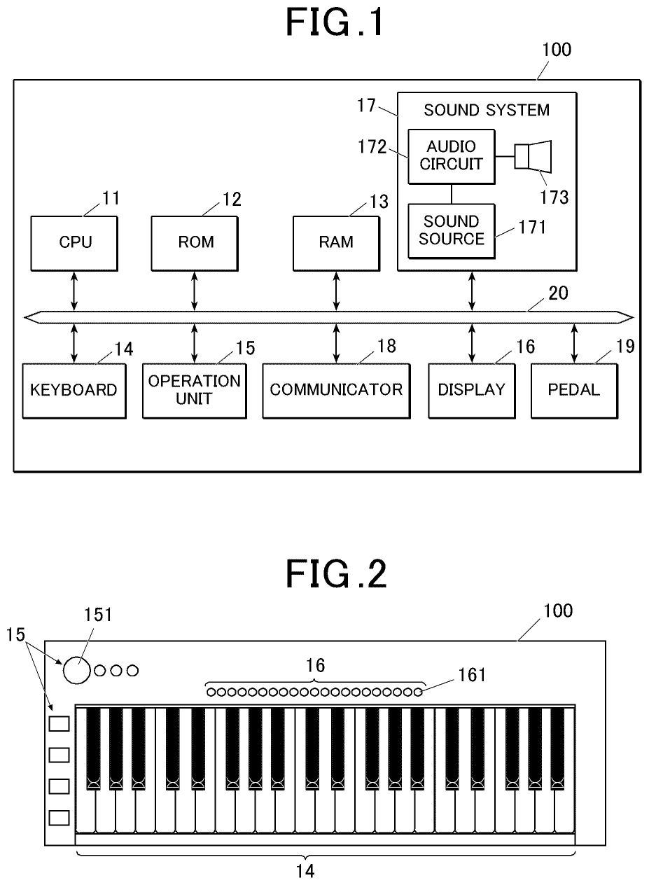

FIG. 1 is a block diagram showing a functional configuration of an electronic musical instrument 100 including the display device of the present disclosure. FIG. 2 shows an example of the external configuration of the electronic musical instrument 100. As shown in FIG. 1 and FIG. 2, the electronic musical instrument 100 includes at least one processor, such as a central processing unit (CPU) 11, a read only memory (ROM) 12, a random access memory (RAM) 13, a keyboard 14, an operation unit 15, a display 16, a sound system 17, a communicator 18 and pedal(s) 19. These components are connected to one another by a bus 20. The electronic musical instrument 100 includes components of the display device of the present disclosure.

The CPU 11 (controller) reads programs and data stored in the ROM 12 and performs various processes using the RAM 13 as a work area, thereby centrally controlling the components of the electronic musical instrument 100. For example, the CPU 11 causes the sound system 17 to output an instrumental sound of a piano or the like based on operations on keys of the keyboard 14 (performance operations) and operations on the pedals 19 (performance operations). The CPU 11 also causes the sound system 17 to play music based on audio data that are input signals input from an external device through the communicator 18. The CPU 11 also causes the sound system 17 to output (play), as a performance assist, a model performance of a song selected by an operation on the operation unit 15. Further, the CPU 11 causes the display 16 to display metronome indications in response to a metronome playing instruction made by an operation on the operation unit 15. Still further, the CPU 11 records a user performance (records/stores user's performance information in a not-shown recording buffer of the RAM 13) based on operations on the keys of the keyboard 14, operations on the pedals 19 and so forth in response to a recording instruction made by an operation on the operation unit 15, and causes the sound system 17 to play the recorded user performance in response to an operation on the operation unit 15. Yet further, the CPU 11 performs a display control process described below in cooperation with program(s) stored in the ROM 12, thereby controlling display of the display 16.

The ROM 12 stores programs, various data and so forth. For example, the ROM 12 stores the program(s) for the display control process described below. The ROM 12 also stores pieces of information displayable by the display 16 and pieces of information on display patterns of the display 16 corresponding to the respective pieces of information displayable by the display 16. The RAM 13 provides the CPU 11 with a memory space for working and temporarily stores data. As the recording buffer, the RAM 13 stores user's performance information. The RAM 13 also stores information on settings of various functions, such as display settings of the display 16.

As shown in FIG. 2, the keyboard 14 includes a plurality of keys (performance operation elements), and outputs information on keys pressed/released (key press/key release) and information on their strength (velocity) to the CPU 11.

As shown in FIG. 2, the operation unit 15 includes various operation buttons and switches including a power button 151, and outputs operation signals corresponding to user operations on the operation buttons and switches to the CPU 11. The operation unit 15 may include a tap operation element to detect a user's finger on the basis of change in capacitance.

As shown in FIG. 2, the display 16 includes a plurality of light emitters 161 (e.g., light emitting diodes (LEDs)) arranged side by side to form a line in the arrangement direction of the keys of the keyboard 14 (first direction). In accordance with an instruction from the CPU 11, each of the light emitters 161 is turned on or off to display a predetermined piece of information. The display 16 may further include a liquid crystal display (LCD) or the like.

The sound system 17 includes a sound source 171, an audio circuit 172 and speakers 173. In accordance with a control instruction from the CPU 11, the sound source 171 reads waveform data (audio data) stored in advance in the ROM 12 or generates waveform data, and outputs the waveform data to the audio circuit 172. The audio circuit 172 performs D/A conversion on the waveform data (audio data) output from the sound source 171 and amplifies the generated data. The speakers 173 output the amplified analog sound. The speakers 173 are disposed on the left and the right of the electronic musical instrument 100. Sound signals based on a left sound source of the audio data are output from the left speaker 173, and sound signals based on a right sound source of the audio data are output from the right speaker 173. If the audio data is monaural, sound signals based on the audio data are output from the left and right speakers 173.

The communicator 18 transmits and receives data to and from external devices, such as an external terminal, connected via a communication network, such as the Internet, Bluetooth®, or a communication interface, such as a universal serial bus (UBS) cable.

The pedals 19 include, for example, damper pedal(s), and outputs information on ON/OFF (pedal depression/pedal release) and the depressed amount of each pedal to the CPU 11.

### [Operation of Electronic Musical Instrument 100]

Next, display control in the electronic musical instrument 100 will be described. The display 16 can display any one of a plurality of pieces of information categorized into Groups A to D by changing display patterns to turn on or off each of the light emitters 161. That is, the display 16 displays one piece of a plurality of pieces of information and does not display two or more pieces of the plurality of pieces of information simultaneously.
Group A (first pieces of information): Information pertaining to user's performance operations (information on the strength (velocity) of key press (of the keyboard 14) in a user performance, information on the degree of pedal depression (of the pedals 19), information on the volume of audio data input from an external device, etc.)
Group B (second pieces of information): Information assisting a performance (information on metronome indications, information on the strength (velocity) of key press in a model performance, information on the played position in (playback position of) a recorded user performance, etc.)
Group C (third pieces of information): Information on setting values at the time of function settings of the electronic musical instrument 100 (information on currently-set setting values), information notifying exception occurrence (information on Wait, information on Error, information on Bluetooth connection/disconnection, etc.).
Group D (fourth pieces of information): Information notifying power-on of the electronic musical instrument 100, information on power-off of the electronic musical instrument 100

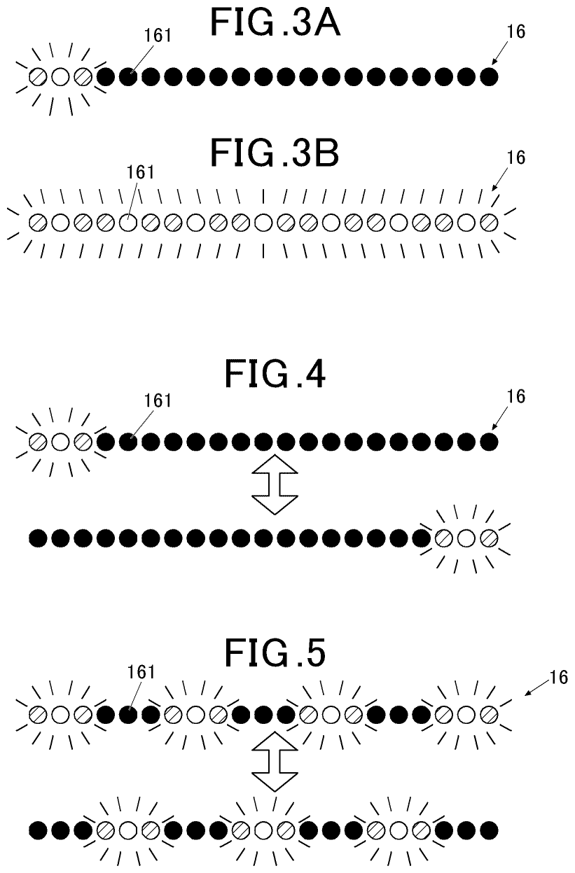

FIG. 3A and FIG. 3B show examples of display patterns of the display 16 each corresponding to the information indicating the strength of key press in a user performance, the information indicating the degree of pedal depression, and the information indicating the strength of key press in a model performance. In FIG. 3A to FIG. 5, hatched circles indicate that the light emitters 161 are emitting light (lighting up or on) at an emission intensity weaker than that indicated by white circles, the white circles indicate that the light emitters 161 are emitting light at the maximum emission intensity, and black circles indicate that the light emitters 161 are not emitting light (not lighting up or off). The display 16 of this embodiment is turned on or off in units of three adjacent light emitters 161 (which hereinafter may be referred to as light emission units). When lighting up, a light emitter 161 at the center among three light emitters 161 lights up at the maximum emission intensity, and the other two light emitters 161 on both sides light up at a predetermined emission intensity weaker than that of the light emitter 161 at the center. Light beams from the three lighted light emitters 161 appear to be a single connected light beam by passing through a not-shown filter. Further, since the light emitters 161 on both sides light up at an emission intensity weaker than that of the light emitter 161 at the center, even if light emission units adjacent to the lighted light emission unit are not emitting light or light emission units at the ends are emitting light, display is not awkward.

FIG. 3A shows an example of a display pattern corresponding to a key(s) of the keyboard 14 being pressed at Level 1, which is the lowest level of the strength among seven levels, or a pedal(s) of the pedals 19 being depressed at Level 1. FIG. 3B shows an example of a display pattern corresponding to a key(s) of the keyboard 14 being pressed at Level 7, which is the highest level of the strength among the seven levels, or a pedal(s) of the pedals 19 being depressed at Level 7. As shown in FIG. 3A and FIG. 3B, the information indicating the strength of key press or the information indicating the degree of pedal depression is expressed by the number of lighted light emitters 161 from the left. If the strength of key press or the degree of pedal depression is weak or low, as shown in FIG. 3A, only three light emitters 161 (one light emission unit) leftmost are turned on, and the remaining light emitters 161 are in the off state. As the strength of key press or the degree of pedal depression is stronger or higher, the number of lighted light emitters 161 increases rightward, and at the highest level, as shown in FIG. 3B, all the light emitters 161 emit light (are in the on state).

FIG. 4 shows an example of a display pattern of the display 16 corresponding to metronome indications. As shown in FIG. 4, as display of metronome indications, the leftmost light emission unit and the rightmost light emission unit are alternately turned on (or off) at a set tempo.

FIG. 5 shows an example of a display pattern of the display 16 corresponding to error information. As shown in FIG. 5, as display of error information, adjacent light emission units are alternately turned on (or off) at a predetermined time (e.g., 0.25 sec.).

As described above, the display 16 displays different pieces of information by switching the pieces of information by switching different display patterns (patterns to turn on or off the light emitters 161). As described above with reference to FIG. 3A, there is a case where the display 16 displays different pieces of information using the same display pattern. This may confuse the user because he/she cannot know which information the display 16 currently displays. Further, information necessary for the user may not be displayed.

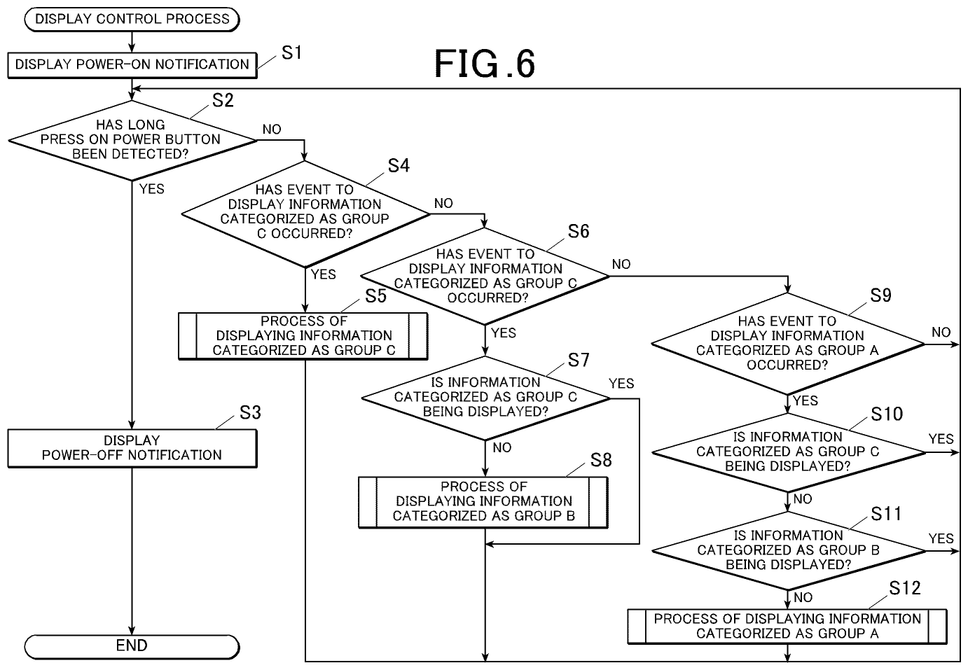

Therefore, in this embodiment, a priority order is set in advance for Groups A to D, and the CPU 11 performs the display control process shown in FIG. 6, thereby performing control to preferentially display (a piece of) information categorized as a group having a higher priority. This lets the user know which information the display 16 currently displays. Further, information necessary for the user can be displayed.

For example, there is a user need to preferentially display the information assisting a performance categorized as Group B, such as the information on metronome indications or the information on the strength of key press in a model performance, rather than the information on his/her performance operations categorized as Group A. As another example, while the user is doing a function setting, the information indicating which setting value is currently set categorized as Group C is more important for the user than the information on his/her performance operations or the information assisting a performance. As another example, if an exceptional situation, such as Wait, Error, or Bluetooth connection/disconnection, occurs in the electronic musical instrument 100, the user needs to recognize the situation immediately. As another example, since a performance, a performance assist, a setting or the like cannot be done during a startup process by power-on and during a power-off process, the highest priority is given to notifying the user about such a situation. Therefore, in this embodiment, the priority order for display is set as follows: Group D>Group C>Group B>Group A. The CPU 11 performs control to preferentially display information categorized as a group having a higher priority. The CPU 11 also performs excessive control not to display pieces of information in each group simultaneously, on the basis of the display setting set (or changed) by the user for each group.

The display settings can be set, for example, by user operations on the operation unit 15 or the like. The set information is stored in the RAM 13. For example, as the display setting for Group A, “Auto”, “Fixed to Velocity”, “Fixed to Pedal”, or “Fixed to Audio Illumination” can be set. In this embodiment, when the information categorized as Group A is to be displayed, if “Auto” has been set, the information indicating the strength (velocity) of key press is displayed by the display 16, if “Fixed to Velocity” has been set, the information indicating the strength (velocity) of key press is displayed by the display 16, if “Fixed to Pedal” has been set, the information indicating the degree of pedal depression is displayed by the display 16, and if “Fixed to Audio Illumination” has been set, the information indicating the volume of audio data input from an external device is displayed by the display 16.

As another example, as the display setting for Group B, “Auto”, “Fixed to Metronome”, or “Fixed to Velocity” can be set. In this embodiment, when the information categorized as Group B is to be displayed, if “Auto” has been set, metronome indications are displayed by the display 16 while a metronome is being played, whereas the information indicating the velocity in a model performance is displayed by the display 16 while not the metronome but the model performance is being played, if “Fixed to Metronome” has been set, metronome indications are displayed by the display 16 while the metronome is being played, and if “Fixed to Velocity” has been set, the information indicating the velocity in a model performance is displayed by the display 16 while the model performance is being played. In the case of Group B, regardless of the display setting, the information indicating the played position in a recorded user performance has the highest priority, and therefore the information indicating the played position in a recorded user performance is displayed by the display 16 while the recorded user performance is being played.

Hereinafter the display control process will be described with reference to FIG. 6. The display control process is performed by the CPU 11 in cooperation with program(s) stored in the ROM 12 when the electronic musical instrument 100 is powered on by the power button 151 being pressed.

First, the CPU 11 causes the display 16 to display the information notifying power-on (Step S1). More specifically, while the electronic musical instrument 100 is starting up by power-on, the CPU 11 controls turn-on/turn-off of each of the light emitters 161 of the display 16 to display the light emitters 161 with a predetermined display pattern corresponding to the information notifying power-on, thereby causing the display 16 to display the information notifying power-on.

Next, the CPU 11 determines whether a long press on the power button 151 has been detected (Step S2).

If the CPU 11 determines in Step S2 that no long press on the power button 151 has been detected (Step S2; NO), the CPU 11 determines whether an event to display the information categorized as Group C has occurred (Step S4). Examples of the event to display the information categorized as Group C include an exception (exceptional situation) and a function setting operation.

If the CPU 11 determines that an event to display the information categorized as Group C has occurred (Step S4; YES), the CPU 11 performs a process of displaying the information categorized as Group C (Step S5) and returns to Step S2. For example, if the CPU 11 determines that an exception has occurred, as the process of displaying the information categorized as Group C, the CPU 11 controls turn-on/turn-off of each of the light emitters 161 of the display 16 to display the light emitters 161 with a predetermined display pattern corresponding to the information notifying the occurred exception. To be more specific, for example, if the CPU 11 determines that an error has occurred, the CPU 11 controls turn-on/turn-off of each of the light emitters 161 of the display 16 to display the light emitters 161 with, for example, the display pattern shown in FIG. 5, thereby causing the display 16 to display the information notifying the occurred exception. As another example, if the CPU 11 determines that a function setting operation has been made using the operation unit 15 or the keyboard 14, the CPU 11 controls turn-on/turn-off of each of the light emitters 161 of the display 16 to display the light emitters 161 with a predetermined display pattern corresponding to the setting value of the function currently set, thereby causing the display 16 to display the information on the setting value at the time of the function setting. If the CPU 11 determines that an exception and a function setting operation have occurred at the same time, the CPU 11 causes the display 16 to display one of the two pieces of information on the basis of a predetermined priority order.

If the CPU 11 determines that no event to display the information categorized as Group C has occurred (Step S4; NO), the CPU 11 determines whether an event to display the information categorized as Group B has occurred (Step S6). Examples of the event to display the information categorized as Group B include start of playing of the metronome, start of playing of a model performance, and start of playing of a recorded user performance.

If the CPU 11 determines that an event to display the information categorized as Group B has occurred (Step S6; YES), the CPU 11 determines whether the information categorized as Group C is being displayed (Step S7). If the CPU 11 determines that the information categorized as Group C is being displayed (Step S7; YES), the CPU 11 returns to Step S2. If the CPU 11 determines that the information categorized as Group C is not being displayed (Step S7; NO), the CPU 11 performs a process of displaying the information categorized as Group B (Step S8).

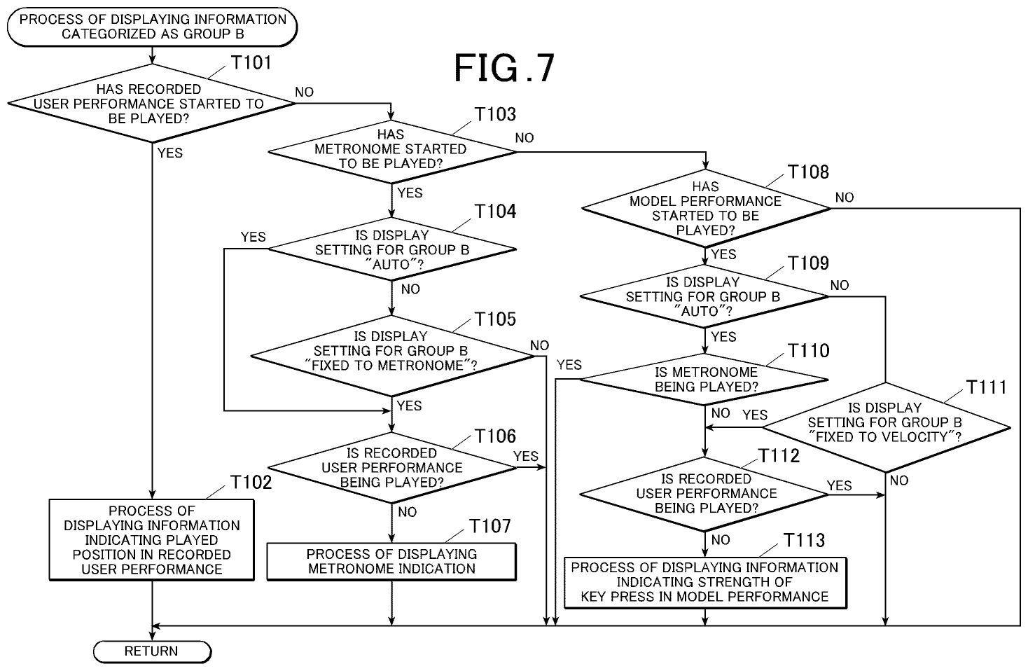

FIG. 7 is a flowchart of the process of displaying the information categorized as B. The process of displaying the information categorized as Group B is performed by the CPU 11 in cooperation with a program stored in the ROM 12.

First, the CPU 11 determines whether a recorded user performance has started to be played (Step T101). A recorded user performance starts to be played in response to a user operation on a predetermined switch or the like of the operation unit 15.

If the CPU 11 determines that a recorded user performance has started to be played (Step T101; YES), the CPU 11 performs a process of displaying the information indicating the played position in the recorded user performance (Step T102) and returns to Step S2 shown in FIG. 6. For example, the CPU 11 controls turn-on/turn-off of each of the light emitters 161 of the display 16 to display the light emitters 161 with a predetermined display pattern corresponding to the currently played position in the recorded user performance, thereby causing the display 16 to display the information indicating the played position in the recorded user performance.

If the CPU 11 determines that no recorded user performance has started to be played (Step T101; NO), the CPU 11 proceeds to Step T103.

The CPU 11 determines in Step T103 whether the metronome has started to be played (Step T103). The metronome is started to be played in response to a user operation on a predetermined switch or the like of the operation unit 15.

If the CPU 11 determines that the metronome has started to be played (Step T103; YES), the CPU 11 determines whether the display setting for Group B is “Auto” (Step T104). If the CPU 11 determines that the display setting for Group B is “Auto” (Step T104; YES), the CPU 11 proceeds to Step T106.

If the CPU 11 determines that the display setting for Group B is not “Auto” (Step T104; NO), the CPU 11 determines whether the display setting for Group B is “Fixed to Metronome” (Step T105). If the CPU 11 determines that the display setting for Group B is not “Fixed to Metronome” (Step T105; NO), the CPU 11 returns to Step S2 shown in FIG. 6. If the CPU 11 determines that the display setting for Group B is “Fixed to Metronome” (Step T105; YES), the CPU 11 proceeds to Step T106.

The CPU 11 determines in Step T106 whether a recorded user performance is being played (Step T106). That is, the CPU 11 determines whether the information indicating the played position in a recorded user performance is being displayed by the display 16. If the CPU 11 determines that a recorded user performance is being played (Step T106; YES), the CPU 11 returns to Step S2 shown in FIG. 6.

If the CPU 11 determines that no recorded user performance is being played (Step T106; NO), the CPU 11 performs a process of displaying metronome indications (Step T107) and returns to Step S2 shown in FIG. 6. For example, the CPU 11 controls turn-on/turn-off of each of the light emitters 161 of the display 16 to display the light emitters 161 with a predetermined display pattern (e.g., the one shown in FIG. 4) corresponding to metronome indications (a tempo set in the metronome), thereby causing the display 16 to display the metronome indications.

If the CPU 11 determines that not the metronome (Step T103; NO) but a model performance has started to be played (Step T108; YES), the CPU 11 determines whether the display setting for Group B is “Auto” (Step T109). A model performance is started to be played in response to a user operation on a predetermined switch or the like of the operation unit 15.

If the CPU 11 determines that the display setting for Group B is “Auto” (Step T109; YES), the CPU 11 determines whether the metronome is being played (Step T110). That is, the CPU 11 determines whether metronome indications are being displayed by the display 16. If the CPU 11 determines that the metronome is being played (Step T110; YES), the CPU 11 returns to Step S2 shown in FIG. 6. If the CPU 11 determines that the metronome is not being played (Step T110; NO), the CPU 11 proceeds to Step T112.

If the CPU determines that the display setting for Group B is not “Auto” (Step T109; NO), the CPU 11 determines whether the display setting for Group B is “Fixed to Velocity” (Step T111). If the CPU 11 determines that the display setting for Group B is not “Fixed to Velocity” (Step T111; NO), the CPU 11 returns to Step S2 shown in FIG. 6. If the CPU 11 determines that the display setting for Group B is “Fixed to Velocity” (Step T111; YES), the CPU 11 proceeds to Step T112.

The CPU 11 determines in Step T112 whether a recorded user performance is being played (Step T112). That is, the CPU 11 determines whether the information indicating the played position in a recorded user performance is being displayed by the display 16. If the CPU 11 determines that a recorded user performance is being played (Step T112; YES), the CPU 11 returns to Step S2 shown in FIG. 6. If the CPU 11 determines that no recorded user performance is being played (Step T112; NO), the CPU 11 performs a process of displaying the information indicating the strength (velocity) of key press in a model performance (Step T113) and returns to Step S2 shown in FIG. 6. For example, the CPU 11 controls turn-on/turn-off of each of the light emitters 161 of the display 16 to display the light emitters 161 with a predetermined display pattern (e.g., the one shown in FIG. 3A or FIG. 3B) corresponding to the strength of key press in a model performance, thereby causing the display 16 to display the information indicating the strength of key press in the model performance.

Returning to FIG. 6, if the CPU 11 determines in Step S6 that no event to display the information categorized as Group B has occurred (Step S6; NO), the CPU 11 determines whether an event to display the information categorized as Group A has occurred (Step S9). If the CPU 11 determines that no event to display the information categorized as Group A has occurred (Step S9; NO), the CPU 11 returns to Step S2. If the CPU 11 determines that an event to display the information categorized as Group A has occurred (Step S9; YES), the CPU 11 determines whether the information categorized as Group C is being displayed (Step S10). If the CPU 11 determines that the information categorized as Group C is being displayed (Step S10; YES), the CPU 11 returns to Step S2. If the CPU 11 determines that the information categorized as Group C is not being displayed (Step S10; NO), the CPU 11 determines whether the information categorized as Group B is being displayed (Step S11). If the CPU 11 determines that the information categorized as Group B is being displayed (Step S11; YES), the CPU 11 returns to Step S2. If the CPU 11 determines that the information categorized as Group B is not being displayed (Step S11; NO), the CPU 11 performs a process of displaying the information categorized as Group A (Step S12) and returns to Step S2.

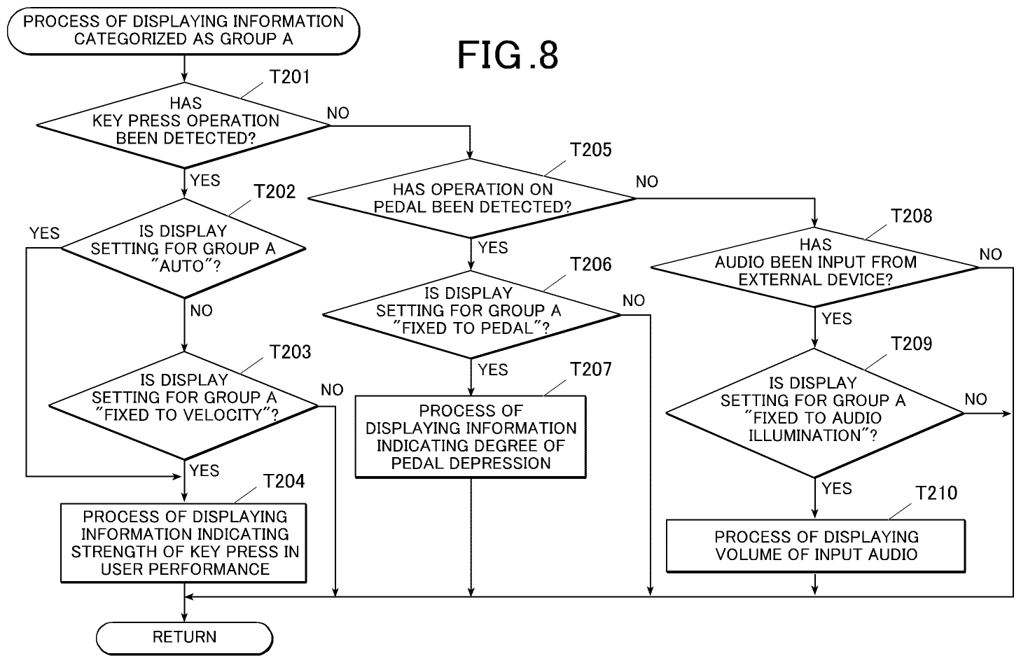

FIG. 8 is a flowchart of the process of displaying the information categorized as Group A. The process of displaying the information categorized as Group A is performed by the CPU 11 in cooperation with a program stored in the ROM 12.

First, the CPU 11 determines whether a key press operation (performance operation) on the keyboard 14 has been detected (Step T201). If the CPU 11 determines that a key press operation on the keyboard 14 has been detected (Step T201; YES), the CPU 11 determines whether the display setting for Group A is “Auto” (Step T202). If the CPU 11 determines that the display setting for Group A is “Auto” (Step T202; YES), the CPU 11 proceeds to Step T204. If the CPU 11 determines that the display setting for Group A is not “Auto” (Step T202; NO), the CPU 11 determines whether the display setting for Group A is “Fixed to Velocity” (Step T203). If the CPU 11 determines that the display setting for Group A is not “Fixed to Velocity” (Step T203; NO), the CPU 11 returns to Step S2 shown in FIG. 6. If the CPU 11 determines that the display setting for Group A is “Fixed to Velocity” (Step T203; YES), the CPU 11 proceeds to Step T204.

In Step T204, the CPU 11 performs a process of displaying the information indicating the strength (velocity) of key press in a user performance (Step T204) and returns to Step S2 shown in FIG. 6. For example, the CPU 11 controls turn-on/turn-off of each of the light emitters 161 of the display 16 to display the light emitters 161 with a predetermined display pattern (e.g., the one shown in FIG. 3A or FIG. 3B) corresponding to the strength of key press on the keyboard 14, thereby causing the display 16 to display the information indicating the strength of key press in the user performance.

If the CPU 11 determines that no key press operation on the keyboard 14 has been detected (Step T201; NO), the CPU 11 determines whether an operation on a pedal (pedal depression operation) of the pedals 19 has been detected (Step T205). If the CPU 11 determines that an operation on a pedal of the pedals 19 has been detected (Step T205; YES), the CPU 11 determines whether the display setting for Group A is “Fixed to Pedal” (Step T206). If the CPU 11 determines that the display setting for Group A is not “Fixed to Pedal” (Step T206; NO), the CPU 11 returns to Step S2 shown in FIG. 6. If the CPU 11 determines that the display setting for Group A is “Fixed to Pedal” (Step T206; YES), the CPU 11 performs a process of displaying the information indicating the degree of pedal depression (Step T207) and returns to Step S2 shown in FIG. 6. For example, the CPU 11 controls turn-on/turn-off of each of the light emitters 161 of the display 16 to display the light emitters 161 with a predetermined display pattern (e.g., the one shown in FIG. 3A or FIG. 3B) corresponding to the degree of pedal depression, thereby causing the display 16 to display the information indicating the degree of pedal depression.

If the CPU 11 determines that no operation on a pedal of the pedals 19 has been detected (Step T205; NO), the CPU 11 determines whether audio data has been input from an external device through the communicator 18 (Step T208). If the CPU 11 determines that no audio data has been input from an external device through the communicator 18 (Step T208; NO), the CPU 11 returns to Step S2 shown in FIG. 6.

If the CPU 11 determines that audio data has been input from an external device through the communicator 18 (Step T208; YES), the CPU 11 determines whether the display setting for Group A is “Fixed to Audio Illumination” (Step T209). If the CPU 11 determines that the display setting for Group A is not “Fixed to Audio Illumination” (Step T209; NO), the CPU 11 returns to Step S2 shown in FIG. 6. If the CPU 11 determines that the display setting for Group A is “Fixed to Audio Illumination” (Step T209; YES), the CPU 11 performs a process of displaying the volume of the input audio data (Step T210) and returns to Step S2 shown in FIG. 6.

For example, in Step T210, the CPU 11 controls turn-on/turn-off of each of the light emitters 161 of the display 16 to display the light emitters 161 with a predetermined display pattern corresponding to the volume of the input audio data, thereby causing the display 16 to display the information indicating the volume of the input audio data.

Returning to Step S2 shown in FIG. 6, if the CPU 11 determines that a long press on the power button 151 has been detected (Step S2; YES), the CPU 11 causes the display 16 to display the information notifying power-off (Step S3) and ends the display control process. For example, the CPU 11 controls turn-on/turn-off of each of the light emitters 161 of the display 16 to display the light emitters 161 with a predetermined display pattern indicating that the power is being turned off, thereby causing the display 16 to display the information notifying power-off. When the power is completely turned off, the CPU 11 ends the display control process accordingly.

As described above, the CPU 11 of the electronic musical instrument 100 causes the display 16 to preferentially display a second piece of information included in a plurality of pieces of information rather than a first piece of information included in the plurality of pieces of information in accordance with a set priority order, the first piece of information corresponding to a performance operation(s) of a user and the second piece of information assisting a performance of the user. Thus, the display device of the electronic musical instrument 100 can display information necessary for the user well.

The display 16 includes the light emitters 161 disposed side by side in a first direction, and the CPU 11 controls each of the light emitters 161 to be on or off to display the light emitters 161 with a display pattern of display patterns corresponding to the respective pieces of information. Thus, the display 16 that displays only one piece of information at a time can display information necessary for the user well.

Those described in the above embodiment are not limitations but some preferred examples of the display device, the electronic musical instrument, the display control method and the storage medium storing the programs of the present disclosure.

For example, in the above embodiment, the display device of the present disclosure is included in the electronic musical instrument 100, but may be included in a separate device connected to the electronic musical instrument 100. For example, the display device of the present disclosure may be included in an information processing device, such as a personal computer (PC), a smartphone or a tablet terminal, connected to the electronic musical instrument 100.

Further, in the above embodiment, the display 16 includes the light emitters 161 and displays (a piece of) information by turning on or off each of the light emitters 161, but the display system of the display of the present disclosure is not limited thereto. For example, the display system thereof may be a display system of displaying (a piece of) information on an LCD screen. Further, the number of light emitters 161 shown in the drawings is not a limitation but an example, and also the display patterns of the light emitters 161 for the respective pieces of information described above are not limitations but examples either.

Further, the pieces of information categorized into Groups A to D and displayable by the display 16 are not limitations but examples, either. For example, one or more pieces of the pieces of information described above and one or more pieces of information not described above may be used as pieces of information displayable by the display 16.

Further, in the above embodiment, the ROM 12, which is a semiconductor memory, is used as the computer-readable storage medium storing the programs of the present disclosure, but the computer-readable storage medium of the present disclosure is not limited thereto. For example, an HDD or a portable recording/storage medium, such as a CD-ROM, may be used as the computer-readable storage medium. Further, as a medium that provides data of the programs of the present disclosure via a communication line, a carrier wave may be used.

The other detailed configuration, components and operation of the electronic musical instrument can also be changed as appropriate without departing from the scope of the present disclosure.

Although one or more embodiments have been described above, the technical scope of the present disclosure is not limited to the embodiments described above, but defined on the basis of claims. The technical scope of the present disclosure further includes the scope of equivalents with changes from the scope of claims added, the changes being irrelevant to the essence of the present disclosure.

1. A display device comprising:
a display that displays one piece of a plurality of pieces of information and does not display two or more pieces of the plurality of pieces of information simultaneously; and
a processor that causes the display to preferentially display a second piece of information included in the plurality of pieces of information rather than a first piece of information included in the plurality of pieces of information in accordance with a set priority order, the first piece of information corresponding to a performance operation of a user and the second piece of information assisting a performance of the user.

2. The display device according to claim 1,
wherein the display includes a plurality of light emitters disposed side by side in a first direction, and
wherein the processor controls each of the plurality of light emitters to be on or off to display the plurality of light emitters with a display pattern of display patterns corresponding to the respective pieces of information.

3. The display device according to claim 1, wherein the plurality of pieces of information includes a third piece of information pertaining to a setting of an electronic musical instrument.

4. The display device according to claim 3, wherein the plurality of pieces of information includes a fourth piece of information pertaining to power-on or power-off of the electronic musical instrument.

5. The display device according to claim 4, wherein in the set priority order, the fourth piece of information is higher than the third piece of information, and the third piece of information is higher than the second piece of information.

6. An electronic musical instrument comprising:
the display device according to claim 1; and
a performance operation element.

7. A display control method that is performed by a computer of a display device including a display that displays one piece of a plurality of pieces of information and does not display two or more pieces of the plurality of pieces of information simultaneously, comprising:
causing the display to preferentially display a second piece of information included in the plurality of pieces of information rather than a first piece of information included in the plurality of pieces of information in accordance with a set priority order, the first piece of information corresponding to a performance operation of a user and the second piece of information assisting a performance of the user.

8. The display control method according to claim 7,
wherein the display includes a plurality of light emitters disposed side by side in a first direction, and
wherein the computer controls each of the plurality of light emitters to be on or off to display the plurality of light emitters with a display pattern of display patterns corresponding to the respective pieces of information.

9. The display control method according to claim 7, wherein the plurality of pieces of information includes a third piece of information pertaining to a setting of an electronic musical instrument.

10. The display control method according to claim 9, wherein the plurality of pieces of information includes a fourth piece of information pertaining to power-on or power-off of the electronic musical instrument.

11. The display control method according to claim 10, wherein in the set priority order, the fourth piece of information is higher than the third piece of information, and the third piece of information is higher than the second piece of information.

12. A non-transitory computer-readable storage medium storing a program that causes, of a display device including a display that displays one piece of a plurality of pieces of information and does not display two or more pieces of the plurality of pieces of information simultaneously, a computer to:
cause the display to preferentially display a second piece of information included in the plurality of pieces of information rather than a first piece of information included in the plurality of pieces of information in accordance with a set priority order, the first piece of information corresponding to a performance operation of a user and the second piece of information assisting a performance of the user.
